(19) United States
(12) Patent Application Publication
(10) Pub. No.: US 2004/0001339 A1
(43) Pub. Date: Jan. 1, 2004

(54) Lighting apparatus

(76) Inventor: Leonard E. Black, Milton (CA)

Correspondence Address: Sam Cini, Signage Systems, 2677 Drew Road, Mississauga, ON, L4T 3X1, CA

(21) Appl. No.: 10/184,390

(22) Filed: Jun. 27, 2002

(51) Int. Cl. H01R 33/08; F21V 23/06

(52) U.S. Cl. 362/221; 362/226; 362/225; 439/239; 439/226

(57) ABSTRACT

A lighting apparatus includes a lamp tube having a back-bend electrode section, a lamp support structure supporting the lamp tube, and a pair of electrical contacts. The contacts include a contact member and a contact clip configured to snap into electrical connection with each other upon forceful engagement of the contact member with the contact clip against a spring force of the contact clip. One of the contacts is electrically connected with the electrode section of the lamp tube. That contact is supported by the lamp support structure in a load bearing relationship separate from the lamp tube so as to transmit the spring force from the contact clip to the support structure separately from the lamp tube upon forceful engagement of the contact member with the contact clip. This helps to avoid breakage of the lamp tube.

### FIELD OF THE INVENTION

The present invention relates to lighting systems that include elongated lamp tubes.

### BACKGROUND OF THE INVENTION

A lighting system may include elongated lamp tubes that are electrically interconnected at their opposite ends. The electrical connections between the lamp tubes are typically established by socket structures that clamp or otherwise engage the lamp tubes directly to hold them in place.

### SUMMARY OF THE INVENTION

In accordance with a principal feature of the invention, a lighting apparatus includes a lamp tube having a back-bend electrode section, a lamp support structure supporting the lamp tube, and a pair of electrical contacts. The contacts include a contact member and a contact clip. The contact clip is configured to snap into electrical connection with the contact member upon forceful engagement of the contact member with the contact clip against a spring force of the contact clip.

One of the contacts is electrically connected with the electrode section of said lamp tube. That contact is supported by the lamp support structure in a load bearing relationship separate from the lamp tube so as to transmit the spring force from the contact clip to the support structure separately from the lamp tube upon forceful engagement of the contact member with the contact clip. This helps to avoid breakage of the lamp tube.

In accordance with another principal feature of the invention, a lighting apparatus includes a lamp tube having a back-bend electrode section, and further includes a lamp support structure supporting the lamp tube, with the lamp support structure having first and second parts. The first and second parts of the lamp support structure have first and second arcuate inner edge surface portions, respectively, at the periphery of an opening extending through said lamp support structure. The bend-back electrode section of said lamp tube extends through the opening.

### BRIEF DESCRIPTION OF THE DRAWINGS

FIG. 1 is a side view of a lighting apparatus.

FIG. 2 is a top view of parts shown in FIG. 1.

FIG. 3 is an enlarged partial view of parts shown in FIG. 1.

FIG. 4 is an exploded view of parts shown in FIG. 3.

FIG. 5 is a view taken on line 5-5 of FIG. 1.

FIG. 6 is a view showing the parts of FIG. 5 in interconnected positions.

### DESCRIPTION

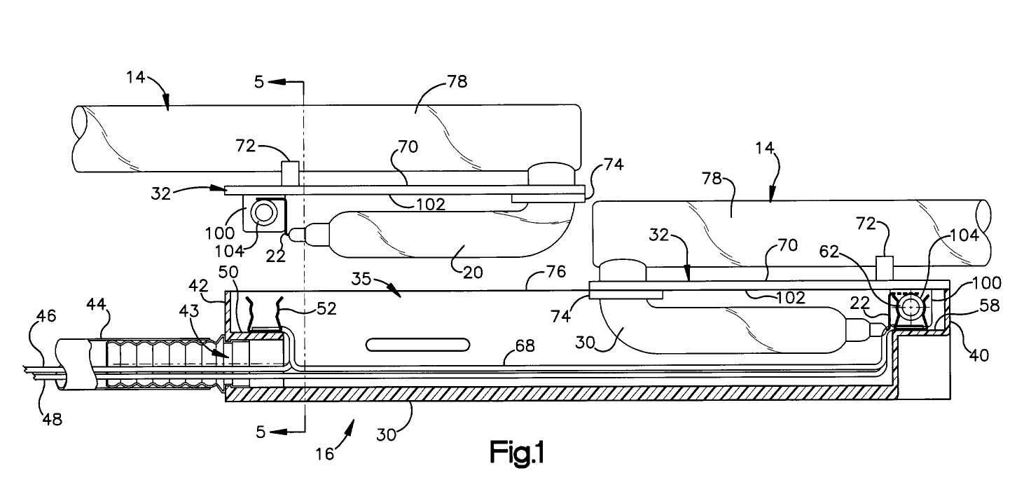

The apparatus 10 shown in FIG. 1 has parts which, as described below, are examples of the elements recited in the claims. These include a pair of lamp tubes 14 and an enclosure 16 for the adjacent end portions of the lamp tubes 14. When the lamp tubes 14 are installed in the enclosure 16, they are interconnected with a power supply through electrical connections that are made within the enclosure 16.

The lamp tubes 14 are alike. Each lamp tube 14 has a back-bend electrode section 20 at each of its opposite ends, as indicated by the oppositely oriented lamp tubes 14 shown partially in FIG. 1. A corresponding electrode wire 22 extends outward from each electrode section 20.

The enclosure 16 includes a rectangular box 30 and a pair of covers 32 for closing the open top 35 of the box 30. Mounting tabs 36 (FIG. 2) project transversely from the side walls 38 of the box 30 for attachment to a wall or other mounting surface. The end wall 40 at one end of the box 30 is closed, but the end wall 42 at the other end of the box 30 has an opening 43 in which a conduit 44 is received to feed electrical wires 46 and 48 into the box 30.

An inner platform surface 50 extends across the inside of the box 30 above the opening 43 in the end wall 42. A pair of flexible electrical contact clips 52 are mounted on the platform surface 50 near the adjacent corners 54 of the box 30. Another inner platform surface 58 is located at the closed end wall 40 of the box 30. That surface 58 supports a second pair of flexible electrical contact clips 62 beside the corners 64 at that end of the box 30.

One of the first contact clips 52 is connected to the power supply by a first wire 46. One of the second contact clips 62 is connected to the ballast by a second wire 48. The other two contact clips 52 and 62 are connected to each other by a third wire 68.

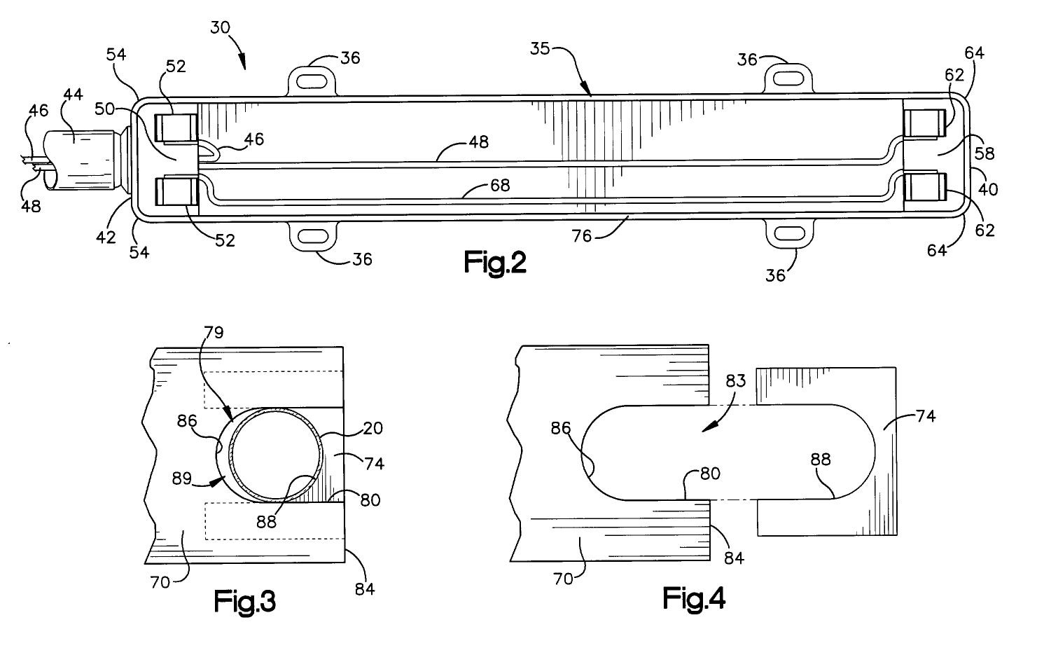

Each cover 32 engages and supports a corresponding lamp tube 14. Accordingly, the covers 32 also are alike and oriented oppositely relative to each other. More specifically, each cover 32 includes a rectangular plate 70, a tube stand 72, and an end piece 74. The plate 70 is sized and shaped to rest on the upper edge surface 76 of the box 30 so as to close one half of the open top 35, and can be releasably fastened to the box 30 by any suitable fastener structure known in the art. The major section 78 of the corresponding lamp tube 14 rests on the tube stand 72. The electrode section 20 extends from the major section 78 through an opening 79 (FIG. 3) in the cover 32.

The opening 79 in the cover 32 is defined in part by the plate 70 and in part by the end piece 74. As best shown in FIG. 4, an inner edge surface 80 of the plate 70 defines a notch 83 extending from the adjacent terminal end 84 of the plate 70. A portion 86 of the inner edge surface 80 has a circular contour and faces outward of the notch 83. The end piece 74 also has an edge surface portion 88 with a circular contour. When the end piece 74 is installed on the plate 70 in the position shown in FIGS. 1 and 3, the edge surface portions 86 and 88 are located at the periphery of the opening 79 on opposite sides of the electrode section 20 of the lamp tube 14. The end piece 74 is adhesively bonded to the plate 70, and is preferably installed such that a clearance space 89 (FIG. 3) is provided between the electrode section 20 and at least one of the opposed inner edge surface portions 86 and 88 so that the lamp tube 14 can shift as needed relative to the cover 32.

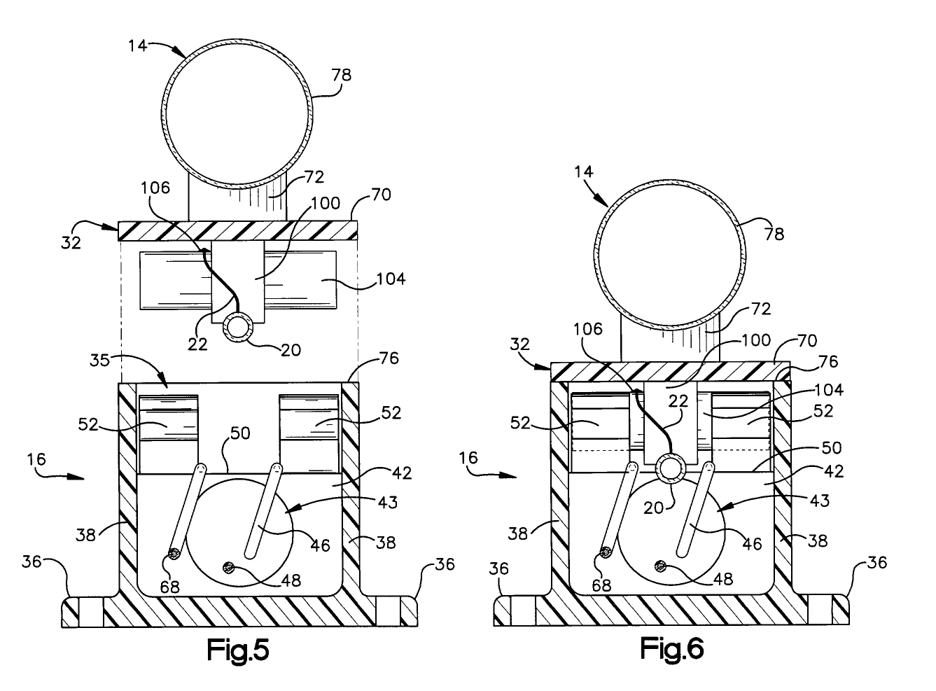

Each cover 32 further includes a terminal block 100 which projects downward, as viewed in the drawings, from the inner side 102 of the plate 70. A contact member in the form of a cylindrical brass bar 104 is received tightly through a circular opening in the terminal block 100. The electrode wire 22 is electrically connected to the contact bar 104 at a soldered connection 106 (FIG. 5).

The lamp tube 14 and cover 32 shown at the left side of FIG. 1 are movable together into the box 30 to take installed positions beside the lamp tube 14 and cover 32 shown at the right side of FIG. 1. The corresponding contact bar 104 is then moved into a position in which it bridges the first contact clips 52 to connect the electrode wire 22 electrically with the first contact clips 52. This is accomplished by manually holding the plate 70 and pressing it downward to move the contact bar 104 forcefully between the arms of the contact clips 52 against the spring forces of the contact clips 52. The contact bar 104 is then captured releasably between the arms of the contact clips 52 as the arms of the clips 52 snap into engagement with the bar 104. Importantly, the cover 32 supports both the lamp tube 14 and the contact bar 104, but supports the contact bar 104 on the terminal block 100 and, in turn, on the plate 70 in a load bearing relationship separate from the lamp tube 14. This enables the contact bar 104 to transmit the spring forces from the contact clips 52 to the cover 32 separately from the lamp tube 14 when the contact bar 104 is being pressed into engagement with the contact clips 52.

This written description uses examples to disclose the invention, including the best mode, and also to enable a person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A lighting apparatus comprising:
a lamp tube having a back-bend electrode section;
a lamp support structure supporting said lamp tube; and
a pair of electrical contacts;
said contacts including a contact member and a contact clip configured to snap into electrical connection with each other upon forceful engagement of said contact member with said contact clip against a spring force of said contact clip;
one of said contacts being electrically connected with said electrode section of said lamp tube, and further being supported by said lamp support structure in a load bearing relationship separate from said lamp tube so as to transmit said spring force from said contact clip to said support structure separately from said lamp tube upon said forceful engagement of said contact member with said contact clip.

2. An apparatus as defined in claim 1 wherein said one of said contacts is said contact member.

3. An apparatus as defined as defined in claim 2 wherein said contact member is a cylindrical brass bar.

4. An apparatus as defined in claim 1 wherein said one of said contacts is electrically connected with said electrode section of said lamp tube by a wire extending from said electrode section of said lamp tube to said one of said contacts.

5. An apparatus as defined in claim 1 further comprising a box in which the other of said contacts is mounted, with said lamp support structure comprising a closure for said box.

6. An apparatus as defined in claim 1 wherein said lamp support structure has first and second parts respectively having first and second arcuate inner edge surface portions at the periphery of an opening extending through said lamp support structure, and said bend-back electrode section of said lamp tube extends through said opening.

7. An apparatus as defined claim 6 wherein said first part of said lamp support structure is a rectangular plate with a notch extending from an end of said plate, and said second part of said lamp support structure is an end piece closing said notch at said end of said plate.

8. A lighting apparatus comprising:
a lamp tube having a back-bend electrode section; and
a lamp support structure supporting said lamp tube;
said lamp support structure having first and second parts which respectively have first and second arcuate inner edge surface portions at the periphery of an opening extending through said lamp support structure, with said bend-back electrode section of said lamp tube extending through said opening.

9. An apparatus as defined in claim 8 wherein said first part of said lamp support structure is a rectangular plate with a notch extending from an end of said plate, and said second part of said lamp support structure is an end piece closing said notch at said end of said plate.

10. An apparatus as defined in claim 8 wherein said opening includes clearance space for said electrode section of said lamp tube to shift in said opening.
